(19) United States
(12) Patent Application Publication
(10) Pub. No.: US 2025/0131797 A1
(43) Pub. Date: Apr. 24, 2025

(54) DICE WAGERING EVENT TO ALTER TABLE GAME OUTCOME

(71) Applicant: IGT, Las Vegas, NV (US)

(72) Inventor: Dwayne NELSON, Las Vegas, NV (US)

(73) Assignee: IGT, Las Vegas, NV (US)

(21) Appl. No.: 18/491,501

(22) Filed: Oct. 20, 2023

(51) Int. Cl. G07F 17/32

(52) U.S. Cl. CPC G07F 17/3262; G07F 17/323; G07F 17/3267; G07F 17/3286

(57) ABSTRACT

A method including receiving, by a player and via a user interface, an outcome of a primary wager game played by the player, providing, to the player, an offer to make a secondary wager game that comprises an alteration output that alters the outcome of the primary wager game. The secondary wager game includes randomly selecting one of multiple values. Operations include receiving, from the player, a first input that causes the secondary wager game to be performed and determining the alteration output that is associated with the secondary wager game. Operations include receiving, from the player, a second input that causes a second secondary wager to be performed a second time and altering, based on the alteration output corresponding to the first input and the second input, the output of the primary wager game.

### BACKGROUND

Embodiments described herein relate to game play features with electronic wagering games, and in particular to a secondary game feature for altering a table game outcome in a gaming environment, such as in a casino environment, and related devices, systems, and methods. Some wagering games, such as card games provided at electronic gaming tables (EGTs), may include blackjack and/or poker games, among others that may be provided in a casino environment, may accept wagers for a primary wagering game at different amounts. Once a wagering event has occurred, a player may become impatient or bored with the time spent between events. There may be a need to provide the player with additional wagering opportunities to keep the player's interest.

### BRIEF SUMMARY

According to some embodiments, a system includes a user interface, a processor circuit and a memory including machine-readable instructions. When executed by the processor circuit, the instructions cause the processor circuit to receive, by a player and via the user interface, an outcome of a primary wager game played by the player and to provide, to the player and via the user interface, an offer to make a secondary wager game that includes an alteration output that alters the outcome of the primary wager game. The secondary wager game may be performed by selecting one of multiple values. The processor circuit may be caused to receive, from the player and via the user interface an input that causes the secondary wager game to be performed, determine the alteration output that is associated with the secondary wager game and alter or not alter, based on the alteration output from the secondary wager game and the output of the primary wager game.

According to some embodiments, a method includes receiving, by a player and via a user interface, an outcome of a primary wager game played by the player, providing, to the player and via the user interface, an offer to make a secondary wager game that includes an alteration output that alters the outcome of the primary wager game. The secondary wager game includes a randomly selected one of multiple values. Operations may includes receiving, from the player and via the user interface, a first input that causes the secondary wager game to be performed and determining the alteration output that is associated with the secondary wager game. Operations may include receiving, from the player and via the user interface, a second input that causes a second secondary wager to be performed a second time and altering, based on the alteration output corresponding to the first input and the second input, the output of the primary wager game.

According to some embodiments, a gaming device includes a user interface, a processor circuit, and a memory including machine-readable instructions. When executed by the processor circuit, the instructions cause the processor circuit to provide, to a player and via the user interface, an offer to play a wager game that comprises game play that a player may select to play unaltered or altered if the player selects a value. The processor circuit is further caused to receive, from the player and via the user interface, selection to play unaltered or altered and if altered selection of the value. The processor circuit is further caused to determine, (i) if the selection is to play unaltered, an unaltered output of the unaltered wager game and (ii) if the selection is to play altered, an altered output of the altered wager game based on the received value.

According to some embodiments, a gaming device includes a display device, an input device; a processor circuit; and a memory comprising machine-readable instructions that, when executed by the processor circuit, cause the processor circuit to determine an outcome of a primary wager game that includes a first type of wagering game. The processor circuit is further caused to, based on the outcome of the primary wager game being a losing outcome, offer a secondary wager game that includes a second type of wagering game that is different from the first type of wagering game. The processor circuit is further caused to, based on an alteration output that corresponds to the secondary wager game, alter the output of the primary wager game.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 is a schematic sequence diagram illustrating a secondary wager game affecting a primary wager game output according to some embodiments herein.

FIG. 4 is a flowchart illustrating operations of systems/methods of a secondary wager game affecting a primary wager game output, according to some embodiments.

FIG. 5 is a flowchart illustrating operations of systems/methods of a secondary wager game affecting a primary wager game output, according to some embodiments.

FIG. 6 is a flowchart illustrating operations of systems/methods of a secondary wager game affecting a primary wager game output, according to some embodiments.

FIG. 7 is a flowchart illustrating operations of systems/methods of a secondary wager game affecting a primary wager game output, according to some embodiments.

### DETAILED DESCRIPTION

Embodiments herein provide for an additional wager, and/or side bet, that can be used in a table game and/or an Electronic Table Game (ETG). In some embodiments, the player can purchase insurance and/or a side bet to enable them to toss a die roll to alter a blackjack hand either before playing the hand or after playing the hand. Various embodiments change the way the wagering works. Embodiments herein may be described in terms of blackjack, however, the concept may be used in many games and/or types thereof including bacarrat, poker and/or other table games, among others.

Some embodiments provide that at the evaluation (end of game) of a blackjack game, the player can roll 1 or more dice to adjust the blackjack out outcome. If the player busts (cards add up to more than 21), the player can roll 1 die and subtract the die value from the busted blackjack hand. In some embodiments, the die roll is offered at a cost/wager. Some embodiments provide that the value of the die roll is subtracted from the player hand. In a non-limiting example, a player is dealt 17 and hits. The next card dealt is a king so the player busts with a 27 (17+king=27). According to some embodiments, the player may purchase the die roll and may roll a 6. The blackjack hand is now 27−6=21 so the player wins the blackjack hand assuming it beats the dealer hand value.

In some embodiments, the game may calculate the wager cost for the die roll based on the busted hand value and/or the dealer hand value. In some embodiment, determining the wager cost may be performed using a look-up table of dealer hand values and player busted hand values to determine the wager cost.

In some embodiments, the player may be able to purchase more than one die roll. Some embodiments provide that such wager may cost less because rolling two dice can create values up to 12, which may significantly reduce the player hand value.

In some embodiments, the player is able to purchase different sided die rolls for different wager amounts. For example, the player might be able to roll 4, 6, 8 10, etc. sided die, each with a different wager amount.

In some embodiments, the player purchases the die roll after seeing their hand value. In some other embodiments, the player purchases the die roll, before the game starts. In such embodiments, the purchase of the die roll may function as an insurance type of bet.

In some embodiments, the player may purchase multiple successive die rolls. In such embodiments, there may be a limit of how many die rolls may be purchased. For example, such embodiments may provide that each alternating die roll alternately subtracts then adds to the hand value. Each roll may costs a wager. For example, the player busts with a 22 and the dealer has a 20. The player rolls the die for a 6, which results in player 16 and dealer 20. Since the player still loses, the player purchases another roll to ADD to the hand. The player rolls a 6 resulting in player 22 (bust) and dealer 20. The player purchases yet another roll to subtract and rolls a 1. The result is player 21 and dealer 20. The player has finally won after purchasing 3 die rolls. In some embodiments, the time in which the player can continue to roll die may be limited such as limited to 30 seconds or limited to within 10 seconds after the ETG game is finished. Such time limit may prevent a delay in the table game play.

In some embodiments, while playing an ETG, a player may experience idle time if they bust while waiting for other players to finish their hands with the dealer. During this idle time, the player may bet and roll a die on the ETG screen and play this side bet to alter the table game outcome. In this regard, the idle time between hands may be occupied with the additional wagers and an outcome of the table game may be altered.

Some embodiments may be used with electronic gaming tables and/or with real gaming tables. For example, some embodiments may be performed in the context of a real blackjack table and/or real dice and/or may be on an EGM. Depending on the context of the game being played, certain values may be more applicable than others. In such embodiments, value generating devices may include non-die elements such as wheels and/or reels. In some embodiments, dice having different values and/or more or less than six sides may be used. For example, a value generating device may include values from 1-5 and/or 2-7, among others. I like dice because it feels natural.

In some embodiments, the dice rolls could alter the dealers hand alternatively and/or in addition to the player's hand. For example, the die roll could add or subtract the players hand value. In another example, one die alters the players hand value (add or subject) while the second die alters the dealers hand value.

In a live table event the dice toss could be physical dice while in the ETG embodiments the dice toss would likely be an on screen representation of the dice.

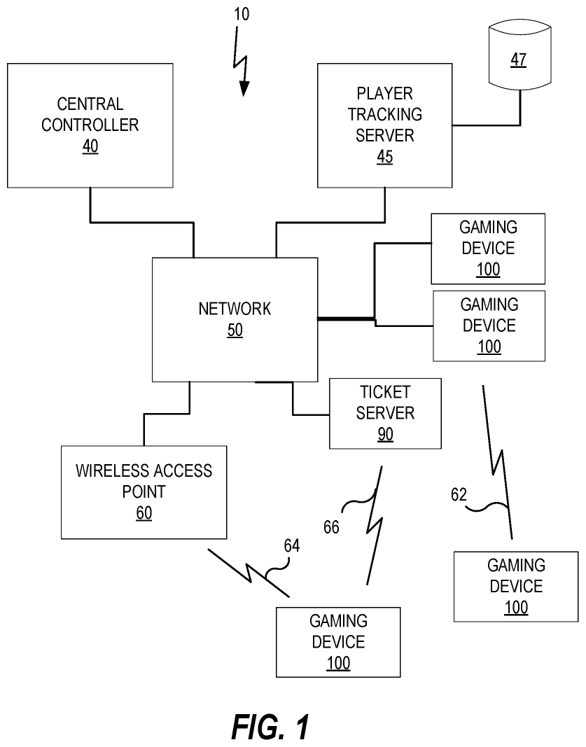

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

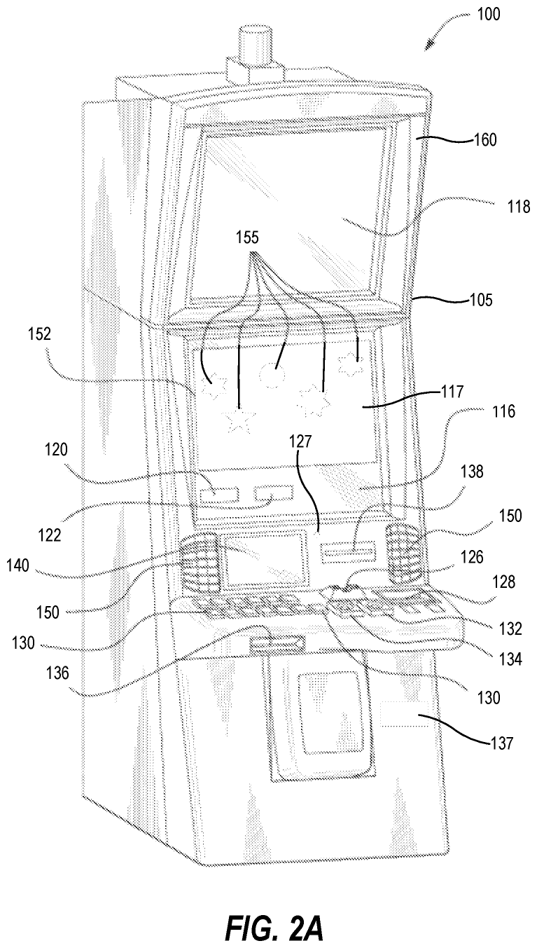

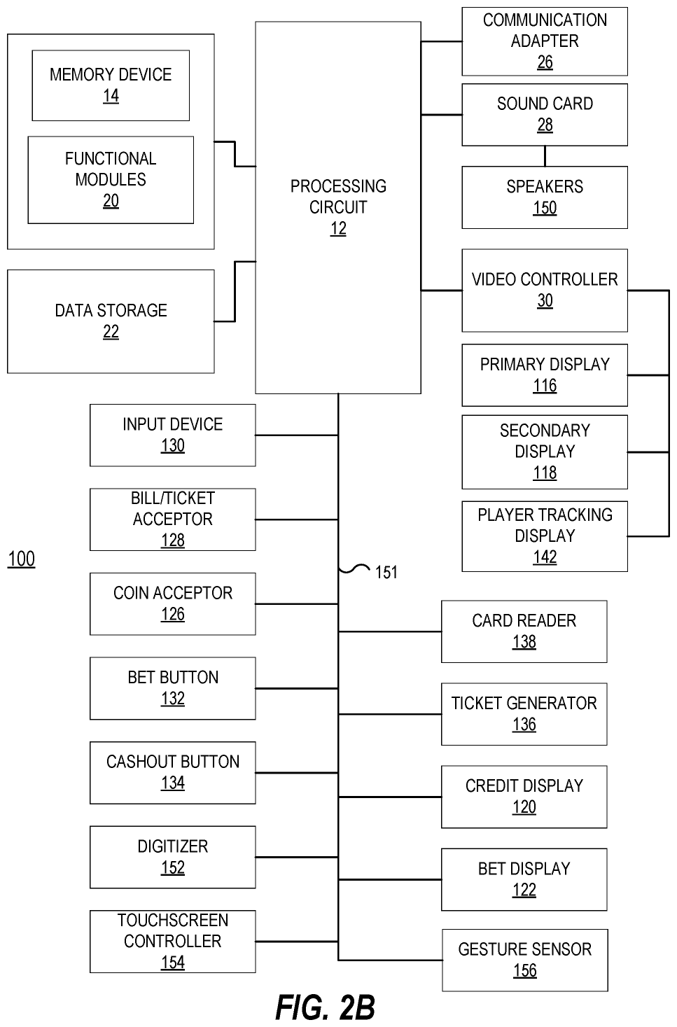

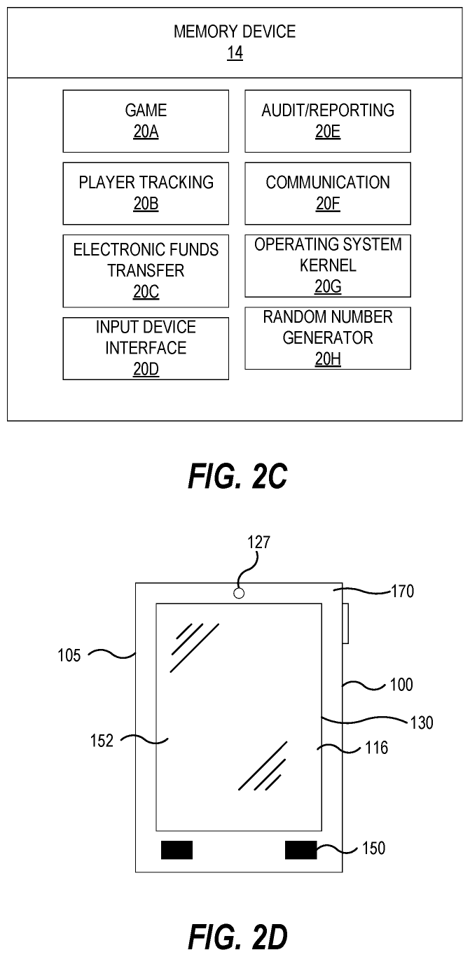

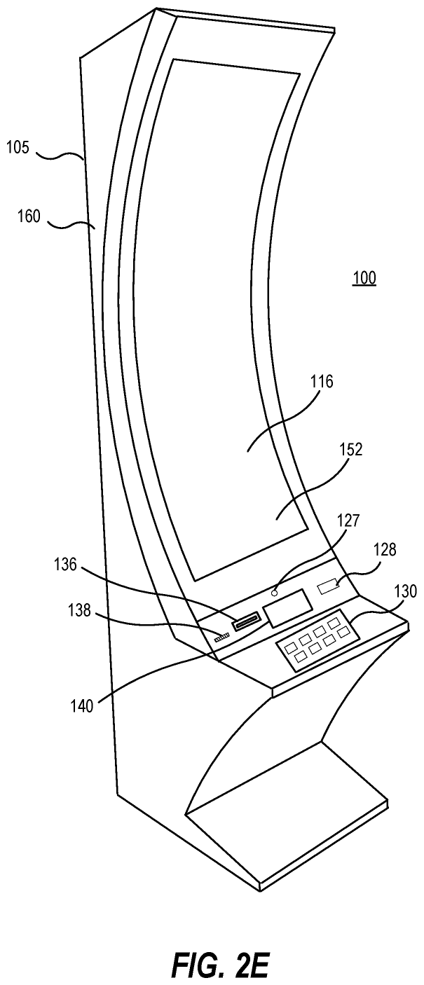

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

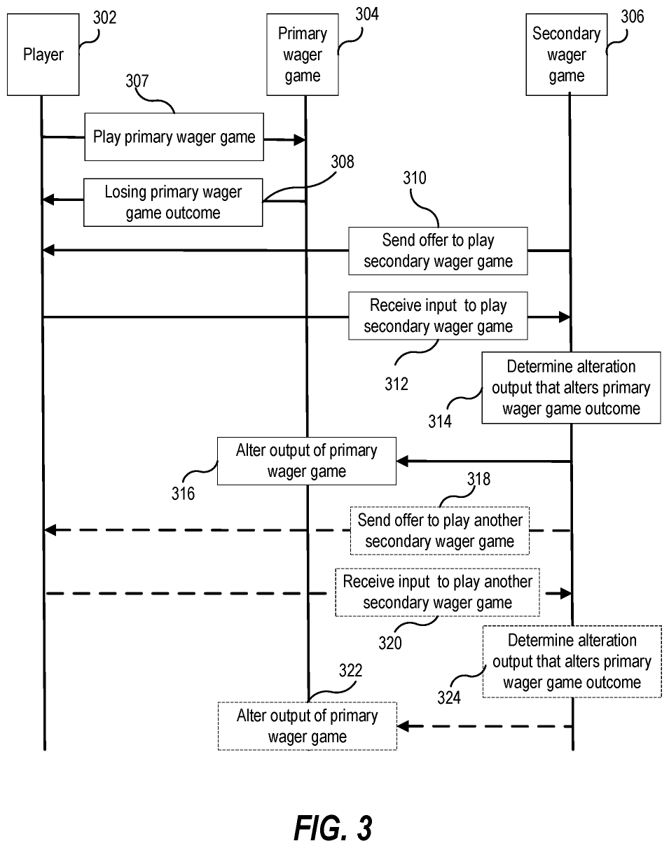

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Reference is now made to FIG. 3, which is a schematic sequence diagram illustrating an example of a secondary wager game affecting a primary wager game output according to some embodiments herein. Some embodiments provide that a primary wager game 304 is played 307 by a player 302. The result of the primary wager game 304 is that the player loses the primary wager game outcome 308. Based on the player receiving the indication that the primary wager game 304 has a losing outcome, a secondary wager game 306 may send an offer to the player offering to play the secondary wager game 310. In some embodiments, the offer to play the secondary wager game 310 may be sent to the player 302 via the primary wager game 304 while in other embodiments, the offer to play the secondary wager game 310 may be sent directly to the player 302 from the secondary wager game 306.

The secondary wager game 306 may receive 312, from the player 302, an input 312 to play the secondary wager game. In some embodiments, the input is received directly from the player 302 while in another embodiments, the input may be received via the primary wager game. Based on an alternation output determination 314 by the secondary wager game 306 the outcome of the primary wager game may be altered 316.

In some optional embodiments, the secondary wager game 306 may send an offer 318 to the player 302 to play another secondary wager game. The secondary wager game 306 may receive an input to play another secondary wager game 320. Based on an alternation output determination 324 by the second secondary wager game 306 the outcome of the primary wager game may be altered 322.

In some embodiments, the primary wager game 304 and/or the secondary wager game 306 may be performed using one or more processing circuits. For example, functions of the primary wager game 304 and the secondary wager game 306 may be performed by the same processing circuit. Some embodiments provide that each of the primary wager game and the secondary wager game are performed by separate and different processing circuits.

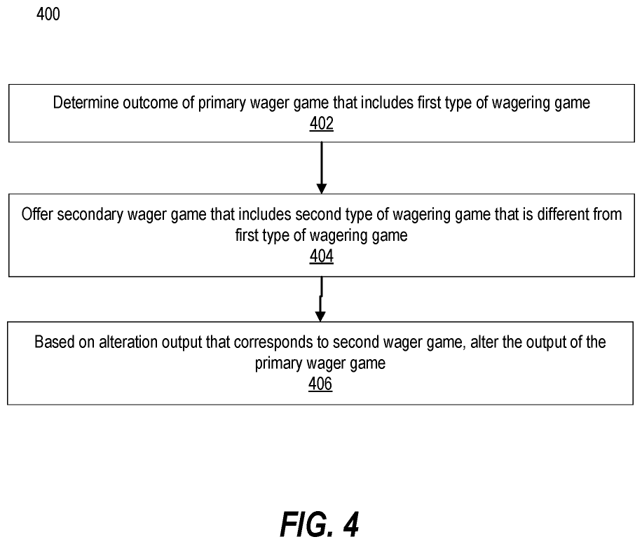

Reference is now made to FIG. 4, which is a flowchart illustrating operations of systems/methods a secondary wager game affecting a primary wager game output, according to some embodiments. Operations 400 include determining (block 402) an outcome of a primary wager game that includes a first type of wagering game and, based on the outcome of the primary wager game being a losing outcome, offering (block 404) a secondary wager game that includes a second type of wagering game that is different from the first type of wagering game. Operations may include, based on an alteration output that corresponds to the secondary wager game, altering (block 406) the output of the primary wager game.

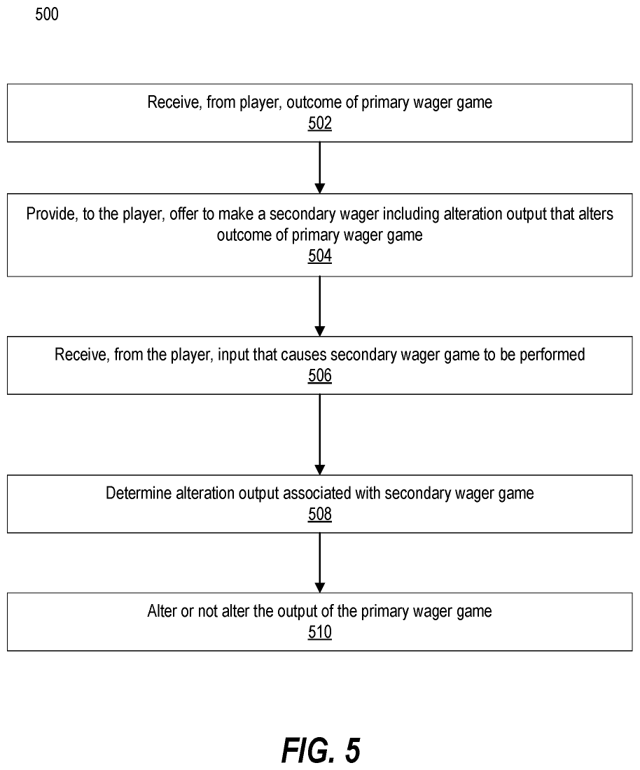

Reference is now made to FIG. 5, which is a flowchart illustrating operations of systems/methods of a secondary wager game affecting a primary wager game output, according to some embodiments. Operations 500 may include receiving (block 502), by a player and via the user interface, an outcome of a primary wager game played by the player. Some embodiments include providing (block 504) to the player and via the user interface, an offer to make a secondary wager game that includes an alteration output that alters the outcome of the primary wager game. For example, the player may receive an undesirable outcome in a black jack hand and may cause the second wager game to be performed by rolling one or more die. If the outcome from the die roll, when used to adjust the outcome of the first wager game.

In some embodiments, the secondary wager game is performed by selecting one of multiple values. For example, the selection may define how many dice, how many faces are on one or more die, the color of one or more faces on a die and/or the range of numerical values that are on a face of a die.

Operations may include receiving (block 506), from the player and via the user interface an input that causes the secondary wager game to be performed and determining (block 508) the alteration output that is associated with the secondary wager game. Operations may include altering or not altering (block 510), based on the alteration output from the secondary wager game, the output of the primary wager game.

In some embodiments, playing the secondary wager game includes receiving, from the player via the user interface, a secondary wager game cost. For example, the value of the outcome of the primary wager game may determine the cost of performing the secondary wager game.

As provided above, the secondary wager game may include a dice game. In such embodiments, the dice game may include a die that includes multiple faces and the secondary wager game may have a cost that is based on a quantity of the multiple faces. In some embodiments, the cost for the secondary wager game is a fixed cost that does not depend on the outcome of the primary wager game. Some embodiments disclosed herein may have six faces, however, such embodiments are non-limiting because a die may have more or less than six faces.

In some embodiments, the primary wager game includes a card game that is provided using an electronic table game. Such embodiments may provide that the secondary wager game includes a dice game that is provided using the electronic table game.

In some embodiments, playing the secondary wager game includes receiving, from the player via the user interface, a secondary wager game cost. In such embodiments, the secondary wager game cost includes a fixed amount.

Some embodiments provide that the secondary wager game cost is based on odds of improving the output of the primary wager game.

In some embodiments, the dice game includes a die that includes multiple faces that each include a face value. Based on odds of improving the output of the primary wager game, the face value on at least one of the multiple of faces may be changed.

Some embodiments provide that the dice game includes multiple dice that each include multiple faces. A first die of the multiple dice is configured to alter the output of the primary wager game in a first manner and a second die of the multiple dice is configured to alter the output of the primary wager game in a second manner that is different from the first manner. For example, some embodiments provide that the first manner includes adding a face value of the first die to the output of the primary wager game and the second manner includes subtracting a face value of the second die to the output of the primary wager game.

In some embodiments, the multiple dice include a first die that includes a first quantity of faces and a second die that includes a second quantity of faces.

Some embodiments provide that the secondary wager game includes a dice game that includes a die that includes multiple faces. The secondary wager game cost may be based on the quantity of the faces.

In some embodiments, the secondary wager game is purchased before playing the primary wager game. In such embodiments, the secondary wager game may serve as an insurance for the risk of an undesirable output of the primary wager game.

Some embodiments provide that the primary wager game includes a symbol based game. For example, the secondary wager game may include a dice game including a first die having first die faces and a second die having second die faces. The first die faces include multiple symbols on respective ones of the first die faces and the second die faces include multiple values on the second die faces. The alteration output may include one of the symbols and one of the values.

In some embodiments, determining the alteration output that is associated with the secondary wager game includes determining a first alteration output that is associated with a first secondary wager game. The input that causes the secondary wager game to be performed may include a first input, and operations include receiving, from the player and via the user interface, a second input that causes a second secondary wager to be performed a second time.

In some embodiments, the first input corresponds to an addition of a first alteration output to the output of the primary wager game and the second input corresponds to a subtraction of a second alteration output from the output of the primary wager game.

Operations may include receiving, from the player and via the user interface an input that causes the secondary wager game to be automatically performed responsive to each play of the primary wager game.

In some embodiments, the secondary wager game includes a spinning game that includes a wheel and/or reel that includes multiple wheel values. One of the wheel values may be identified responsive to the wheel and/or reel stopping at a wheel position and the alteration output may be based on the one of the wheel values.

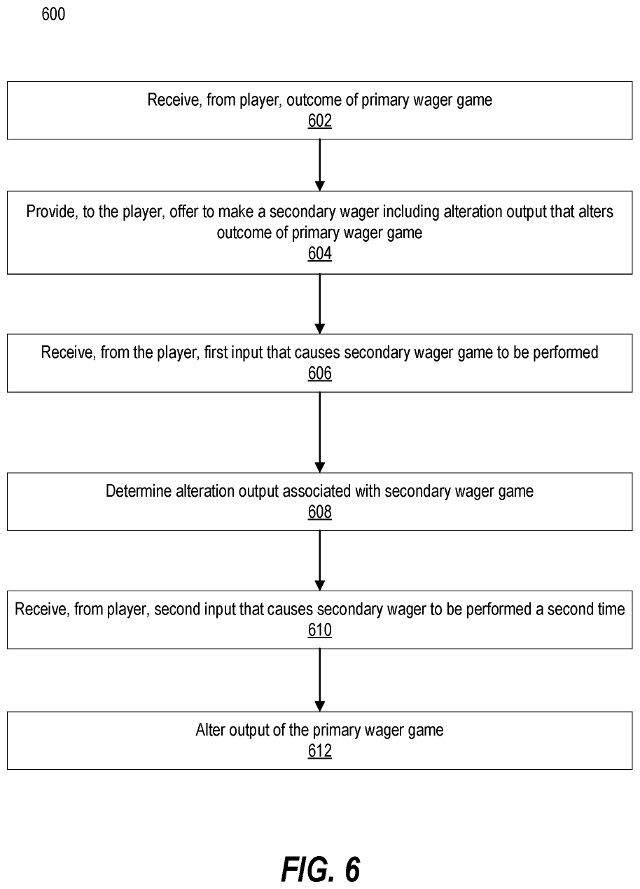

Reference is now made to FIG. 6, which is a flowchart illustrating operations of systems/methods of a secondary wager game affecting a primary wager game output, according to some embodiments. Operations may include receiving (block 602), from a player and via a user interface, an outcome of a primary wager game played by the player. Operations include providing (block 604), to the player and via the user interface, an offer to make a secondary wager game that includes an alteration output that alters the outcome of the primary wager game. In some embodiments, the secondary wager game includes randomly selecting one of multiple values. Examples of such values include values on a face of one or more dice.

Operations may include receiving (block 606), from the player and via the user interface, a first input that causes the secondary wager game to be performed. In some embodiments, the secondary wager game may be provided to the player via the user interface. Operations further include determining (block 608) the alteration output that is associated with the secondary wager game. For example, an alteration output may include the amount and/or manner in which the output of the primary wager game.

Operations may include receiving (block 610), from the player and via the user interface, a second input that causes a second secondary wager to be performed a second time. In such embodiments, the player may decide to try multiple times to improve an output of the primary wager game. Some embodiments provide that one or inputs from the player may cause the secondary wager games to be played automatically based on a specific outcome and/or a lack of specific outcome of the primary wager game. Operations may include altering (block 612), based on the alteration output corresponding to the first input and the second input, the output of the primary wager game.

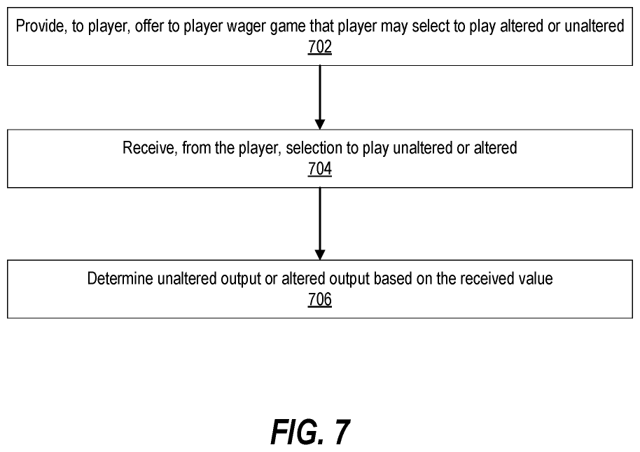

Reference is now made to FIG. 7, which is a flowchart 700 illustrating operations of systems/methods of a secondary wager game affecting a primary wager game output, according to some embodiments. Operations may include providing (block 702), to a player and via the user interface, an offer to play a wager game that includes game play that a player may select to play unaltered or altered if the player selects a value. Operations may include receiving (block 704), from the player and via the user interface, a selection to play unaltered or altered. Based on a selection to play altered, the selection of the value may be included with the selection to play.

Operations may include determining (block 706) an unaltered output or an altered output based on the received value. Responsive to the selection being to determine the play to be unaltered, the output of the wager game is not altered. Responsive to the selection being to play altered, an output of the wager game may be altered based on the received value.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a user interface;
a processor circuit; and
a memory comprising machine-readable instructions that, when executed by the processor circuit, cause the processor circuit to:
receive, from a player and via the user interface, an outcome of a primary wager game played by the player;
provide, to the player and via the user interface, an offer to make a secondary wager game that comprises an alteration output that alters the outcome of the primary wager game, wherein the secondary wager game is performed by selecting one of a plurality of values;
receive, from the player and via the user interface an input that causes the secondary wager game to be performed;
determine the alteration output that is associated with the secondary wager game; and
alter or not alter, based on the alteration output from the secondary wager game and the output of the primary wager game.

2. The system of claim 1, wherein playing the secondary wager game comprises receiving, from the player via the user interface, a secondary wager game cost.

3. The system of claim 2, wherein the secondary wager game comprises a dice game, wherein the dice game comprises a die that comprises a plurality of faces, and wherein the secondary wager game cost is based on a quantity of the plurality of faces.

4. The system of claim 1, wherein the primary wager game comprises a card game that is provided using an electronic table game, and wherein the secondary wager game comprises a dice game that is provided using the electronic table game.

5. The system of claim 4, wherein playing the secondary wager game comprises receiving, from the player via the user interface, a secondary wager game cost and the secondary wager game cost comprises a fixed amount.

6. The system of claim 4, wherein the secondary wager game cost is based on odds of improving the output of the primary wager game.

7. The system of claim 4, wherein the dice game comprises a die that comprises a plurality of faces that each comprise a face value, wherein the processor circuit is further caused to, based on odds of improving the output of the primary wager game, change the face value on one of the plurality of faces.

8. The system of claim 4, wherein the dice game comprises a plurality of die that each comprise a plurality of faces.

9. The system of claim 8, wherein the plurality of dice comprises a first die that alters the output of the primary wager game in a first manner and a second die that alters the output of the primary wager game in a second manner that is different from the first manner.

10. The system of claim 9, wherein the first way comprises adding a face value of the first die to the output of the primary wager game and the second way comprising subtracting a face value of the second die to the output of the primary wager game.

11. The system of claim 8, wherein the plurality of die comprises a first die that comprises a first quantity of faces and a second die that comprises a second quantity of faces.

12. The system of claim 1, wherein the secondary wager game comprises a dice game, and wherein dice game comprises a die that comprises a plurality of faces, and wherein the secondary wager game cost is based on a quantity of the plurality of faces.

13. The system of claim 1, wherein the processor circuit is further caused to purchase the secondary wager game before playing the primary wager game.

14. The system of claim 1, wherein the primary wager game comprises a symbol based game, wherein the secondary wager game comprises a dice game comprising a first die comprising first die faces and a second die comprising second die faces, wherein the first die faces comprise a plurality of symbols on respective ones of the first die faces and the second die faces comprise a plurality of values on the second die faces, wherein the alteration output comprises one of the plurality of symbols and one of the plurality of values.

15. The system of claim 1, wherein determining the alteration output that is associated with the secondary wager game comprises determining a first alteration output that is associated with a first secondary wager game, wherein the input that causes the secondary wager game to be performed comprises a first input, and wherein the processor circuit is further caused to receive, from the player and via the user interface, a second input that causes a second secondary wager to be performed a second time.

16. The system of claim 15, wherein the first input corresponds to an addition of a first alteration output to the output of the primary wager game, and
wherein the second input corresponds to a subtraction of a second alteration output from the output of the primary wager game.

17. The system of claim 1, wherein the processor circuit is further caused to receive, from the player and via the user interface an input that causes the secondary wager game to be automatically performed responsive to each play of the primary wager game.

18. The system of claim 1, wherein the secondary wager game comprises a spinning game that comprises a wheel and/or reel that comprises a plurality of wheel values, wherein one of the plurality of wheel values is identified responsive to the wheel and/or reel stopping at a wheel position, and wherein the alteration output is based on the one of the plurality of wheel values.

19. A method comprising:
receiving, from a player and via a user interface, an outcome of a primary wager game played by the player;
providing, to the player and via the user interface, an offer to make a secondary wager game that comprises an alteration output that alters the outcome of the primary wager game, wherein the secondary wager game comprises randomly selecting one of a plurality of values;
receiving, from the player and via the user interface, a first input that causes the secondary wager game to be performed;
determining the alteration output that is associated with the secondary wager game;
receiving, from the player and via the user interface, a second input that causes a second secondary wager to be performed a second time; and
altering, based on the alteration output corresponding to the first input and the second input, the output of the primary wager game.

20. A gaming device comprising:
user interface;
a processor circuit; and
a memory comprising machine-readable instructions that, when executed by the processor circuit, cause the processor circuit to:
provide, to a player and via the user interface, an offer to play a wager game that comprises game play that a player may select to play unaltered or altered if the player selects a value;
receive, from the player and via the user interface, selection to play unaltered or altered and if altered selection of the value; and
determine, (i) if the selection is to play unaltered, an unaltered output of the unaltered wager game and (ii) if the selection is to play altered, an altered output of the altered wager game based on the received value.
